(19) United States
(12) Patent Application Publication
(10) Pub. No.: US 2015/0065602 A1
(43) Pub. Date: Mar. 5, 2015

(54) ADHESIVE USING WIRE PIGMENT AND MANUFACTURING METHOD THEREOF

(71) Applicant: SAMSUNG ELECTRO-MECHANICS CO., LTD., Suwon-si (KR)

(72) Inventors: Jong Sik KIM, Suwon-si (KR); Yoon Min LEE, Suwon-si (KR); Dae Jun KIM, Suwon-si (KR)

(21) Appl. No.: 14/472,361

(22) Filed: Aug. 28, 2014

(30) Foreign Application Priority Data
Aug. 29, 2013 (KR) 10-2013-0103299

(51) Int. Cl. C09J 133/14; C09J 133/02

(52) U.S. Cl. CPC C09J 133/14; C09J 133/02; C08K 3/08
USPC 522/81; 524/440; 524/549; 524/559; 524/548; 524/555; 522/71

(57) ABSTRACT

The present invention relates to an adhesive using wire pigments and a manufacturing method thereof. According to an embodiment of the present invention, an adhesive using wire pigments, which includes an adhesive resin composition including a photocurable adhesive material; and wire pigments formed in a nano-sized wire structure to be immersed in the adhesive resin composition and having light shielding properties, is provided. Further, a manufacturing method of an adhesive using wire pigments is provided.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2013-0103299, entitled filed Aug. 29, 2013, which is hereby incorporated by reference in its entirety into this application.

### BACKGROUND OF THE INVENTION

1. Field of the Invention

The present invention relates to an adhesive using wire pigments and a manufacturing method thereof, and more particularly, to an adhesive using wire pigments and a manufacturing method thereof that can improve photocurable properties and light shielding properties.

2. Description of the Related Art

A photocurable adhesive has been conventionally used in temperature-sensitive materials (wood, paper, plastic, etc) and mainly used in a process difficult to apply heat. As the economic, environmental, and performance advantages of the photocurable adhesive are highlighted, it is expected that the photocurable adhesive will gradually replace the thermosetting adhesive market. The reason why the photocurable adhesive cannot occupy a high proportion of the adhesive market in spite of the advantages and good functional characteristics of the photocurable adhesive is because of some disadvantages. One of them is a problem with curing a shadow part through which light is not transmitted.

In order to overcome this problem, a dual cure (hybrid type) technology, which can perform thermal curing after photocuring, has been developed. Meanwhile, the dual cure technology may greatly deteriorate photocurable properties according to the content of a pigment.

In recent times, the need for the photocurable adhesive has emerged in the products requiring light shielding properties, such as camera modules. However, when the content of the pigment is increased to improve the light shielding properties, photocurable properties such as the degree of cure in a deep part and adhesive strength may be deteriorated due to the competitive absorption with a photoinitiator.

FIG. 6 shows a conventional dual cure adhesive. Referring to FIG. 6, in the conventional dual cure adhesive, a pigment 20 is uniformly dissolved in an adhesive composition 30 or pigment particles are uniformly dispersed in the adhesive composition 30. At this time, since the pigments are uniformly dispersed, the light shielding properties and the photocurable properties may be deteriorated.

### RELATED ART DOCUMENT

### Patent Document

Patent Document 1: Japanese Patent Publication No. 2003-096424 (laid open on Apr. 3, 2003)

Patent Document 2: Korean Patent Publication No. 10-2009-0071830 (laid open on Jul. 2, 2009)

### SUMMARY OF THE INVENTION

The present invention has been invented in order to overcome the above-described problems and it is, therefore, an object of the present invention to provide an adhesive that can improve light shielding properties and photocurable properties.

In accordance with a first aspect of the present invention to achieve the object, there is provided an adhesive using wire pigments including: an adhesive resin composition including a photocurable adhesive material; and wire pigments formed in a nano-sized wire structure to be immersed in the adhesive resin composition and having light shielding properties.

At this time, in an example, the adhesive resin composition may further include a thermosetting adhesive material.

Further, in an example, a thermosetting monomer or a thermosetting oligomer, which is a thermosetting adhesive material, may be attached to the circumferences of the wire pigments.

Otherwise, in another example, a thermosetting polymer resin, which is a thermosetting adhesive material, may be coated on the circumferences of the wire pigments.

At this time, in another example, the adhesive resin composition may further include a thermosetting adhesive material.

Further, in an example, the wire pigments may have a cross-section of 10 to 300 nm and a length of 1 to 10 μm, and the wire pigments may be at least one carbon or metal pigment selected from the group consisting of carbon (C), titanium (Ti), copper (Cu), iron (Fe), manganese (Mn), silver (Ag), cobalt (Co) and chrome (Cr).

In another example, the photocurable adhesive material may be one or a mixture of two or more selected from the group consisting of a dibasic acid monomer, a dihydric alcohol monomer, an acrylate monomer and a cationic polymerizable monomer, an oligomer obtained by polymerizing one of the above group, or a mixture of oligomers, the dibasic acid monomer may be at least one monomer of fumaric acid, maleic acid and maleic anhydride acid, the acrylate monomer may be at least one monomer of epoxy acrylate, urethane acrylate and polyester acrylate, and the cationic polymerizable monomer may be at least one monomer of diazonium salt, diaryliodonium salt and triarylsulphonium salt.

Further, the thermosetting adhesive material may be one or a mixture of two or more selected from the group consisting of a melamine monomer, a uric acid monomer, a phenolic monomer and an epoxy monomer, an oligomer obtained by polymerizing one of the above group or a mixture of oligomers, or may be made of at least one monomer of the group or an oligomer or an oligomer mixture.

In accordance with another example, the adhesive using wire pigments may include 70 to 94 wt % of the sum of the photocurable adhesive material and a thermosetting adhesive material, wherein the thermosetting adhesive material is included in the adhesive resin composition or/and is attached to the circumferences of the wire pigments, 5 to 15 wt % of the sum of a photoinitiator and a thermal initiator dispersed in the adhesive resin composition, 0.01 to 5 wt % of the wire pigments, and 0.99 to 10 wt % of other additives dispersed in the adhesive resin composition.

At this time, in an example, the weight ratio of the photocurable adhesive material and the thermosetting adhesive material may be 20 to 80 wt % to 80 to 20 wt %, and the weight ratio of the photoinitiator and the thermal initiator may be 20 to 80 wt % to 80 to 20 wt %. Further, at this time, the photoinitiator may include a radical photoinitiator or a cationic photoinitiator, wherein the radical photoinitiator may include one or more of benzophenone, acetophenone and thioxanthone, and the cationic photoinitiator may include onium salt or bronsted-lewis acid, and the thermal initiator may include peroxide or an azo compound, wherein the peroxide may include one or more of R—O—O—R′, RCOOH, benzoyl peroxide and PhC(═O)OOC(═O)Ph, and the azo compound may include R—N═N—R′ or Me₂C(CN)N═NC(CN)Me₂(AlBN).

Next, in accordance with a second aspect of the present invention to achieve the object, there is provided a manufacturing method of an adhesive using wire pigments including: preparing wire pigments having a nano-sized wire structure; and immersing the wire pigments in an adhesive resin composition including a photocurable adhesive material to have light shielding properties.

At this time, in an example, the adhesive resin composition in which the wire pigments are immersed may further include a thermosetting adhesive material.

Further, in an example, in the step of preparing the wire pigments, a thermosetting monomer or a thermosetting oligomer, which is a thermosetting adhesive material, may be attached to the circumferences of the wire pigments and the wire pigments attached with the thermosetting adhesive material may be immersed in the adhesive resin composition.

Otherwise, in another example, in the step of preparing the wire pigments, a thermosetting polymer resin, which is a thermosetting adhesive material, may be coated on the circumferences of the wire pigments and the wire pigments coated with the thermosetting adhesive material may be immersed in the adhesive resin composition.

At this time, in the step of preparing the wire pigments, the wire pigments may be dispersed in a solvent, and a thermosetting monomer or oligomer including a functional group which can be charge-coupled to the wire pigments is added to the solution in which the wire pigments are dispersed, to be attached to the circumferences of the wire pigments by self-assembly.

Further, at this time, in an example, the adhesive resin composition in which the wire pigments are immersed may further include a thermosetting adhesive material.

Further, in an example, the wire pigments may be at least one carbon or metal pigment selected from the group consisting of carbon (C), titanium (Ti), copper (Cu), iron (Fe), manganese (Mn), silver (Ag), cobalt (Co) and chrome (Cr) and have a wire structure with a cross-section of 10 to 300 nm and a length of 1 to 10 μm.

Further, in an example, the adhesive may include 70 to 94 wt % of the sum of the photocurable adhesive material and a thermosetting adhesive material, wherein the thermosetting adhesive material is included in the adhesive resin composition or/and is attached to the circumferences of the wire pigments, 5 to 15 wt % of the sum of a photoinitiator and a thermal initiator dispersed in the adhesive resin composition, 0.01 to 5 wt % of the wire pigments, and 0.99 to 10 wt % of other additives dispersed in the adhesive resin composition.

At this time, in an example, the weight ratio of the photocurable adhesive material and the thermosetting adhesive material may be 20 to 80 wt % to 80 to 20 wt %, and the weight ratio of the photoinitiator and the thermal initiator may be 20 to 80 wt % to 80 to 20 wt %.

Further, the photocurable adhesive material may be one or a mixture of two or more selected from the group consisting of a dibasic acid monomer, a dihydric alcohol monomer, an acrylate monomer and a cationic polymerizable monomer, an oligomer obtained by polymerizing one of the above group, or a mixture of oligomers, the dibasic acid monomer may be at least one monomer of fumaric acid, maleic acid and maleic anhydride acid, the acrylate monomer may be at least one monomer of epoxy acrylate, urethane acrylate and polyester acrylate, and the cationic polymerizable monomer may be at least one monomer of diazonium salt, diaryliodonium salt and triarylsulphonium salt.

In addition, the thermosetting adhesive material may be one or a mixture of two or more selected from the group consisting of a melamine monomer, a uric acid monomer, a phenolic monomer and an epoxy monomer, an oligomer obtained by polymerizing one of the above group or a mixture of oligomers, or may be made of at least one monomer of the group or an oligomer or an oligomer mixture.

Further, at this time, the photoinitiator may include a radical photoinitiator or a cationic photoinitiator, wherein the radical photoinitiator may include one or more of benzophenone, acetophenone and thioxanthone, and the cationic photoinitiator may include onium salt or bronsted-lewis acid, and the thermal initiator may include peroxide or an azo compound, wherein the peroxide may include one or more of R—O—O—R′, RCOOH, benzoyl peroxide and PhC(═O)OOC(═O)Ph, and the azo compound may include R—N═N—R′ or Me₂C(CN)N═NC(CN)Me₂(AlBN).

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view schematically showing an adhesive using wire pigments in accordance with an embodiment of the present invention;

FIG. 2 is a view schematically showing an example of wire pigments in the embodiment according to FIG. 1;

FIG. 3 is a view schematically showing another example of the wire pigments in the embodiment according to FIG. 1;

FIG. 4 is a flowchart schematically showing a manufacturing method of an adhesive using wire pigments in accordance with an embodiment of the present invention;

FIGS. 5a and 5b are flowcharts schematically showing a manufacturing method of an adhesive using wire pigments in accordance with another embodiment of the present invention; and

FIG. 6 is a view schematically showing a conventional adhesive.

### DETAILED DESCRIPTION OF THE PREFERABLE EMBODIMENTS

Embodiments of the present invention to achieve the above-described objects will be described with reference to the accompanying drawings. In this description, the same elements are represented by the same reference numerals, and additional description which is repeated or limits interpretation of the meaning of the invention may be omitted.

In this specification, when an element is referred to as being “connected or coupled to” or “disposed in” another element, it can be “directly” connected or coupled to or “directly” disposed in the other element or connected or coupled to or disposed in the other element with another element interposed therebetween, unless it is referred to as being “directly coupled or connected to” or “directly disposed in” the other element.

Although the singular form is used in this specification, it should be noted that the singular form can be used as the concept representing the plural form unless being contradictory to the concept of the invention or clearly interpreted otherwise. It should be understood that the terms such as “having”, “including”, and “comprising” used herein do not preclude existence or addition of one or more other elements or combination thereof.

Adhesive

First, an adhesive in accordance with a first aspect of the present invention will be specifically described with reference to the drawings. At this time, the reference numeral that is not mentioned in the reference drawing may be the reference numeral that represents the same element in another drawing.

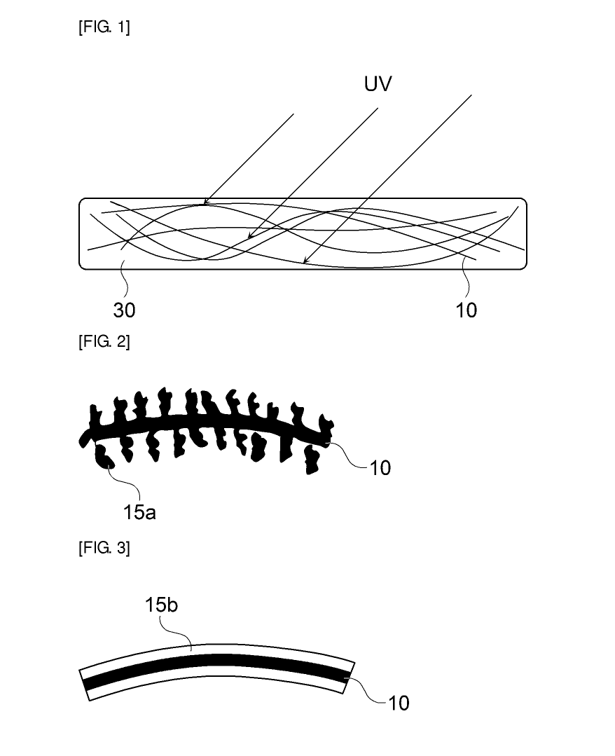

FIG. 1 is a view schematically showing an adhesive using wire pigments in accordance with an embodiment of the present invention, FIG. 2 is a view schematically showing an example of wire pigments in the embodiment according to FIG. 1, and FIG. 3 is a view schematically showing another example of the wire pigments in the embodiment according to FIG. 1.

Referring to FIG. 1, an adhesive using wire pigments according to an example includes an adhesive resin composition 30 and wire pigments 10.

The adhesive resin composition 30 includes a photocurable adhesive material. The photocurable adhesive material is an adhesive material having photocurable properties, for example, a UV curable monomer or oligomer.

For example, in an example, the photocurable adhesive material may be one or a mixture of two or more selected from the group consisting of a dibasic acid monomer, a dihydric alcohol monomer, an acrylate monomer and a cationic polymerizable monomer, an oligomer obtained by polymerizing one of the above group, or a mixture of oligomers. For example, at this time, the dibasic acid monomer may be at least one monomer of fumaric acid, maleic acid and maleic anhydride acid. Further, the acrylate monomer may be at least one monomer of epoxy acrylate, urethane acrylate and polyester acrylate. In addition, the cationic polymerizable monomer may be at least one monomer of diazonium salt, diaryliodonium salt and triarylsulphonium salt.

For example, in an example, the adhesive resin composition 30 may further include a thermosetting adhesive material. At this time, the wire pigments 10 are immersed in the adhesive resin composition 30 in which the photocurable adhesive material and the thermosetting adhesive material are mixed.

For example, at this time, the thermosetting adhesive material may be one or a mixture of two or more selected from the group consisting of a melamine monomer, a uric acid monomer, a phenolic monomer, and an epoxy monomer or an oligomer obtained by polymerizing one of the above group or a mixture of oligomers.

Next, the wire pigments 10 will be described in detail. The wire pigments 10 are formed in a nano-sized wire structure. At this time, the wire pigments 10 are immerged in the adhesive resin composition 30 to have light shielding properties. At this time, the adhesive resin composition 30 includes a photocurable adhesive material. Accordingly, it is possible to implement an adhesive with improved photocurable and light shielding properties by dispersedly immersing the nano-sized wire pigments 10 in the adhesive resin composition 30 and thus transmitting light through the space between the wire pigments 10 to photocure a deep part and secure light shielding properties by the wire pigments 10 at the same time. That is, it is possible to improve photocurable properties such as the degree of cure of a deep part and adhesive strength while maintaining light shielding properties by using the wire pigments 10 having a nano-sized wire structure to minimize the influence of the pigment in the competitive light absorption relationship with a photoinitiator during photocuring.

For example, in an example, the wire pigments 10 may be immersed in the adhesive resin composition 30 including a photocurable adhesive material and a thermosetting adhesive material.

For example, in an example, the wire pigments 10 may have a cross-section of 10 to 300 nm and a length of 1 to 10 μm. For example, the wire pigments 10 may have a cross-section of 30 to 200 nm and a length of 1 to 7 μm. Otherwise, more specifically, for example, the wire pigments 10 may have a cross-section of 50 to 100 nm and a length of 1 to 5 μm.

Further, in an example, the wire pigments 10 may be at least one carbon or metal pigment selected from the group consisting of carbon (C), titanium (Ti), copper (Cu), iron (Fe), manganese (Mn), silver (Ag), cobalt (Co) and chrome (Cr).

Further, an adhesive using wire pigments according to another example will be described with reference to FIGS. 2 and 3. At this time, a thermosetting adhesive material 15a and 15b may be attached to the circumferences of the wire pigments 10. That is, the wire pigments 10 having the circumference attached with the thermosetting adhesive material 15a and 15b may be immersed in the adhesive resin composition 30 including a photocurable adhesive material or in the adhesive resin composition 30 including a photocurable adhesive material and a thermosetting adhesive material according to an example. For example, when the thermosetting adhesive material 15a and 15b is attached to the circumferences of the wire pigments 10, since the contents of the wire pigments 10 are low compared to the total weight of the adhesive composition, a thermosetting adhesive material, for example, a thermosetting monomer or oligomer may be dispersed in the adhesive resin composition 30 to increase the weight ratio of the thermosetting adhesive material.

Referring to FIG. 2, the thermosetting adhesive material attached to the circumferences of the wire pigments 10 may be a thermosetting monomer or a thermosetting oligomer 15a. For example, at this time, the thermosetting adhesive material may be one or a mixture of two or more selected from the group consisting of a melamine monomer, a uric acid monomer, a phenolic monomer, and an epoxy monomer or an oligomer obtained by polymerizing one of the above group or a mixture of oligomers.

Otherwise, referring to FIG. 3, the thermosetting adhesive material attached to the circumferences of the wire pigments 10 may be a thermosetting polymer resin 15b coated on the circumferences of the wire pigments 10. For example, at this time, the thermosetting adhesive material may be a polymer resin made of one or more selected from the group consisting of a melamine monomer, a uric acid monomer, a phenolic monomer, and an epoxy monomer having an amino group. For example, the phenolic monomer may be at least one selected from bisphenol-A, xylenol, phenol, cresol, and alkyl phenol. The epoxy may be an ethylentically unsaturated monomer containing an epoxy group.

For example, according to an example, the adhesive using wire pigments may further include a photoinitiator, a thermal initiator, and other additives dispersed in the adhesive resin composition 30. At this time, the adhesive using wire pigments may include 70 to 94 wt % of the sum of the photocurable adhesive material and a thermosetting adhesive material, wherein the thermosetting adhesive material is included in the adhesive resin composition or/and is attached to the circumferences of the wire pigments, 5 to 15 wt % of the sum of the photoinitiator and the thermal initiator dispersed in the adhesive resin composition 30, 0.01 to 5 wt % of the wire pigments, and 0.99 to 10 wt % of other additives. For example, in an example, the weight ratio of the wire pigments may be 0.01 to 1 wt %.

At this time, when the content of the photocurable adhesive material and the thermosetting adhesive material is low, adhesive strength may be deteriorated, and when the content is high, curing reaction time may be increased. Further, when the content of the photoinitiator is excessive, the degree of cure in a deep part may be deteriorated, and when the content of the photoinitiator is insufficient, curing speed may be very low and hardness may be deteriorated. Further, when the content of the thermal initiator is excessive, polymerization of a photocurable material may be disturbed during photocurable reaction, and when the content of the thermal initiator is insufficient, thermal curing reaction time may be increased. In addition, when the contents of the wire pigments 10 are excessive, the degree of cure in a deep part may be deteriorated and photocurable properties (curing speed and the degree of cure) may be deteriorated. The degree of cure means the degree of completion of reaction and is a measure of curing reaction. When the contents of the wire pigments 10 are insufficient, light shielding properties may be deteriorated and thus light transmittance may be increased.

For example, at this time, in the sum of the photocurable adhesive material and the thermosetting adhesive material, the ratio of the thermosetting adhesive material may be 20 to 80 wt % and the ratio of the photocurable adhesive material may be 80 to 20 wt %. When the thermosetting adhesive material is attached to the circumferences of the wire pigments 10, since the contents of the wire pigments 10 are low compared to the total weight of the adhesive composition, a thermosetting adhesive material, for example, a thermosetting monomer or oligomer may be dispersed in the adhesive resin composition 30 to increase the weight ratio of the thermosetting adhesive material. When the amount of the thermosetting adhesive material is less than 20 wt %, thermosetting reaction time of the adhesive composition tends to increase or adhesive properties of the adhesive composition tends to decrease. When the amount of the thermosetting adhesive material exceeds 80 wt %, polymerization of a photocurable material may be disturbed during photocurable reaction. Further, when the amount of the photocurable monomer or oligomer, that is, the photocurable adhesive material, is less than 20 wt %, photocurable reaction time of the adhesive composition tends to increase or adhesive properties of the adhesive composition tends to decrease, and when the amount of the photocurable monomer or oligomer exceeds 80 wt %, polymerization of a thermosetting material may be disturbed during thermosetting reaction.

Further, the weight ratio of the photoinitiator and the thermal initiator may be 20 to 80 wt % to 80 to 20 wt %. The photoinitiator is a photopolymerization initiator, and the thermal initiator is a thermal polymerization initiator.

At this time, in an example, the photoinitiator may include a radical photoinitiator or a cationic photoinitiator. For example, the radical photoinitiator may include one or more of benzophenone, acetophenone and thioxanthone. Further, the cationic photoinitiator may include onium salt or bronsted-lewis acid.

Further, in an example, the thermal initiator may include peroxide or an azo compound. For example, the peroxide may include one or more of R—O—O—R′, RCOOH, benzoyl peroxide and PhC(═O)OOC(═O)Ph. Further, the azo compound may include R—N═N—R′ or Me₂C(CN)N═NC(CN)Me₂(AlBN).

Further, as other additives, a curing agent, a cross-linking agent, an accelerator, etc. may be selectively included.

The adhesive using wire pigments in accordance with an embodiment of the present invention can be used in a process requiring light shielding properties by improving light shielding properties and photocurable properties. For example, take the case in which the adhesive using wire pigments in accordance with an embodiment of the present invention is used as a photocurable adhesive in a house attaching process of a camera module. For example, in an image sensor attaching process and a house attaching process during manufacture of the camera module, the adhesive composition according to an embodiment of the present invention is coated to attach a lens barrel housing on a PCB to which an image sensor is attached. At this time, photocuring is performed after positioning the house on the adhesive according to an embodiment of the present invention, which is coated on the PCB, by adjusting a tilt to adjust the angle of the image sensor and the lens inside the housing.

Manufacturing method of adhesive

Next, a manufacturing method of an adhesive using wire pigments in accordance with a second aspect of the present invention will be described in detail with reference to the drawings. At this time, the adhesives using a wire pigment according to the above-described embodiments of the first aspect of the present invention and FIGS. 1 to 3 will be referenced. Thus, repeated descriptions may be omitted.

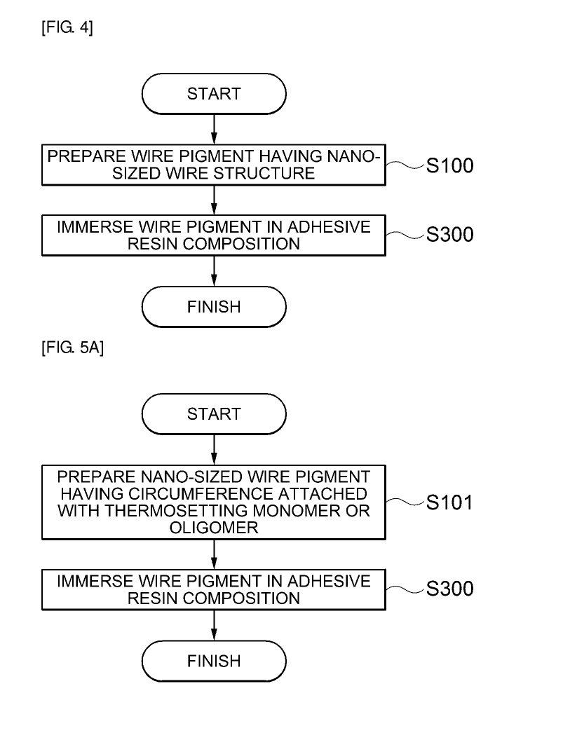

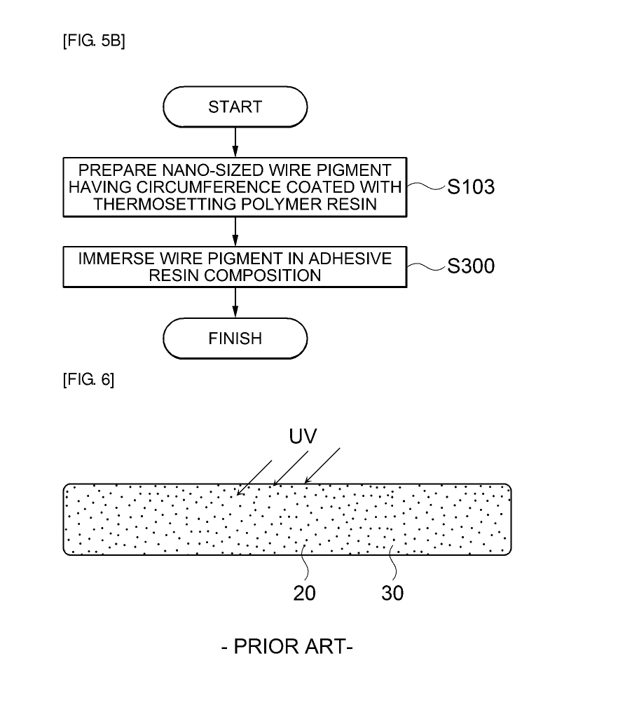

FIG. 4 is a flowchart schematically showing a manufacturing method of an adhesive using wire pigments in accordance with an embodiment of the present invention, and FIGS. 5a and 5b are flowcharts schematically showing a manufacturing method of an adhesive using wire pigments in accordance with another embodiment of the present invention.

Referring to FIGS. 4, 5a, and 5b, a manufacturing method of an adhesive using wire pigments according to an example includes a wire pigment preparation step S100, S101, and S103 and a wire pigment immersion step S300.

In the wire pigment preparation step S100, S101, and S103, wire pigments 10 having a nano-sized wire structure is prepared. For example, the wire pigments 10 may be a wire structure having a cross-section of 10 to 300 nm and a length of 1 to 10 μm.

Further, in an example, the wire pigments 10 may be at least one carbon or metal pigment selected from the group consisting of carbon (C), titanium (Ti), copper (Cu), iron (Fe), manganese (Mn), silver (Ag), cobalt (Co) and chrome (Cr).

For example, an example will be described with reference to FIG. 5a. In the wire pigment preparation step S101, a thermosetting monomer or a thermosetting oligomer 15a, which is a thermosetting adhesive material, may be attached to the circumferences of the wire pigments 10.

For example, in an example, the thermosetting monomer may be one or a mixture of two or more selected from the group consisting of a melamine monomer, a uric acid monomer, a phenolic monomer, and an epoxy monomer. Further, the thermosetting oligomer may be an oligomer obtained by polymerizing one of the above group or a mixture of oligomers.

Specifically, for example, in the wire pigment preparation step S101, first, the wire pigments 10 are dispersed in a solvent. For example, the wire pigments 10 are synthesized or separated in the form of a wire having a cross-section of 10 to 300 nm and a length of 1 to 10 μm, for example, a wire having a cross-section of about 100 nm and a length of about 1 to 3 μm, using carbon, titanium, copper, iron, manganese, silver, cobalt, or chrome and dispersed in the solvent (for example, glycol monobutyl ether acetate). Next, the thermosetting monomer or oligomer 15a including a functional group (for example, —OH, —SH, —NH, etc) which can be charge-coupled to the wire pigments 10 is added to the solution in which the wire pigments 10 are dispersed, and the thermosetting monomer or oligomer 15a is attached to the circumferences of the wire pigments 10 by self-assembly.

Otherwise, referring to FIG. 5b, in another example, in the wire pigment preparation step S103, a thermosetting polymer resin 15b, which is a thermosetting adhesive material, may be coated on the circumferences of the wire pigments 10.

For example, at this time, in the wire pigment preparation step S103, the thermosetting monomer or oligomer including a functional group which can be charge-coupled to the wire pigments 10 is added to the solution in which the wire pigments 10 are dispersed, and the thermosetting polymer resin 15b coating layer may be formed on the circumferences of the wire pigments 10 by polymerization of the thermosetting monomer or oligomer.

For example, in an example, the thermosetting polymer resin 15b may be a polymer resin made of one or more selected from the group consisting of a melamine monomer, a uric acid monomer, a phenolic monomer, and an epoxy monomer.

Further, an adhesive resin composition 30 including a photocurable adhesive material is prepared. The adhesive resin composition 30 is prepared simultaneously with the preparation of the wire pigments 10 or before and after the preparation of the wire pigments 10.

For example, the photocurable adhesive material included in the adhesive resin composition 30 may be one or a mixture of two or more selected from the group consisting of a dibasic acid monomer, a dihydric alcohol monomer, an acrylate monomer and a cationic polymerizable monomer, an oligomer obtained by polymerizing one of the above group, or a mixture of oligomers. For example, at this time, the dibasic acid monomer may be at least one monomer of fumaric acid, maleic acid and maleic anhydride acid. Further, the acrylate monomer may be at least one monomer of epoxy acrylate, urethane acrylate and polyester acrylate. In addition, the cationic polymerizable monomer may be at least one monomer of diazonium salt, diaryliodonium salt and triarylsulphonium salt.

For example, in an example, the adhesive resin composition 30 further including a thermosetting adhesive material in addition to a thermosetting adhesive material may be prepared. At this time, the wire pigments 10 are immersed in the adhesive resin composition 30 further including a thermosetting adhesive material.

For example, the thermosetting adhesive material included in the adhesive resin composition 30 may be one or a mixture of two or more selected from the group consisting of a melamine monomer, a uric acid monomer, a phenolic monomer, and an epoxy monomer or an oligomer obtained by polymerizing one of the above group or a mixture of oligomers.

Next, referring to FIGS. 4, 5a, and 5b, in the wire pigment immersion step S300, the wire pigments 10 are immersed in the adhesive resin composition 30 so that the adhesive can have light shielding properties. At this time, the adhesive resin composition 30 includes a photocurable adhesive material.

For example, in an example, in the wire pigment immersion step S300, the wire pigments 10 may be immersed in the adhesive resin composition 30 further including a thermosetting adhesive material.

Further, referring to FIG. 5a, in an example, in the wire pigment immersion step S300, the wire pigments 10 to which the thermosetting adhesive material, for example, the thermosetting monomer or oligomer 15a is attached by self-assembly may be immersed in the adhesive resin composition 30. Otherwise, referring to FIG. 5b, the wire pigments 10 coated with the thermosetting adhesive material, for example, the thermosetting polymer resin 15b may be immersed in the adhesive resin composition 30.

At this time, the adhesive resin composition 30 may include a photocurable adhesive material. Further, in an example, the adhesive resin composition 30 may further include a thermosetting adhesive material.

Further, a manufacturing method of an adhesive using wire pigments according to an example will be described. At this time, an adhesive is manufactured by immersing wire pigments 10 in an adhesive resin composition 30 further including a photoinitiator, a thermal initiator, and other additives.

At this time, the adhesive may include 70 to 94 wt % of the sum of the photocurable adhesive material and a thermosetting adhesive material, wherein the thermosetting adhesive material is included in the adhesive resin composition or/and is attached to the circumferences of the wire pigments, 5 to 15 wt % of the sum of the photoinitiator and the thermal initiator, 0.01 to 5 wt % of the wire pigments 10, and 0.99 to 10 wt % of other additives.

For example, at this time, in the sum of the photocurable adhesive material and the thermosetting adhesive material, the ratio of the thermosetting adhesive material may be 20 to 80 wt % and the ratio of the photocurable adhesive material may be 80 to 20 wt %. Further, the weight ratio of the photoinitiator and the thermal initiator may be 20 to 80 wt % to 80 to 20 wt %.

For example, at this time, the photoinitiator may include a radical photoinitiator or a cationic photoinitiator. For example, the radical photoinitiator may include one or more of benzophenone, acetophenone and thioxanthone. Further, the cationic photoinitiator may include onium salt or bronsted-lewis acid.

Further, in an example, the thermal initiator may include peroxide or an azo compound. For example, the peroxide may include one or more of R—O—O—R′, RCOOH, benzoyl peroxide and PhC(═O)OOC(═O)Ph, and the azo compound may include R—N═N—R′ or Me₂C(CN)N═NC(CN)Me₂(AlBN).

Further, as other additives, a curing agent, a cross-linking agent, an accelerator, etc. may be selectively included.

According to an embodiment of the present invention, it is possible to implement an adhesive with improved photocurable and light shielding properties.

For example, according to an embodiment of the present invention, it is possible to improve photocurable properties such as the degree of cure in a deep part and adhesive strength while maintaining light shielding properties by using a wire pigment having a nano-sized wire structure to minimize the influence of the pigment in the competitive light absorption relationship with a photoinitiator during photocuring.

Further, the adhesive according to the present invention can be usefully used in a process requiring light shielding properties by improving light shielding properties and photocurable properties.

It is apparent that various effects which have not been directly mentioned according to the various embodiments of the present invention can be derived by those skilled in the art from various constructions according to the embodiments of the present invention.

The above-described embodiments and the accompanying drawings are provided as examples to help understanding of those skilled in the art, not limiting the scope of the present invention. Further, embodiments according to various combinations of the above-described components will be apparently implemented from the foregoing specific descriptions by those skilled in the art. Therefore, the various embodiments of the present invention may be embodied in different forms in a range without departing from the essential concept of the present invention, and the scope of the present invention should be interpreted from the invention defined in the claims. It is to be understood that the present invention includes various modifications, substitutions, and equivalents by those skilled in the art.

What is claimed is:

1. An adhesive using wire pigments, comprising:
an adhesive resin composition including a photocurable adhesive material; and
wire pigments formed in a nano-sized wire structure to be immersed in the adhesive resin composition and having light shielding properties.

2. The adhesive using wire pigments according to claim 1, wherein the adhesive resin composition further comprises a thermosetting adhesive material.

3. The adhesive using wire pigments according to claim 1, wherein a thermosetting monomer or a thermosetting oligomer, which is a thermosetting adhesive material, is attached to the circumferences of the wire pigments.

4. The adhesive using wire pigments according to claim 1, wherein a thermosetting polymer resin, which is a thermosetting adhesive material, is coated on the circumferences of the wire pigments.

5. The adhesive using wire pigments according to claim 3, wherein the adhesive resin composition further comprises a thermosetting adhesive material.

6. The adhesive using wire pigments according to claim 4, wherein the adhesive resin composition further comprises a thermosetting adhesive material.

7. The adhesive using wire pigments according to claim 1, wherein the wire pigments have a cross-section of 10 to 300 nm and a length of 1 to 10 μm, and the wire pigments each are at least one carbon or metal pigment selected from the group consisting of carbon (C), titanium (Ti), copper (Cu), iron (Fe), manganese (Mn), silver (Ag), cobalt (Co) and chrome (Cr).

8. The adhesive using wire pigments according to claim 1, wherein the photocurable adhesive material is one or a mixture of two or more selected from the group consisting of a dibasic acid monomer, a dihydric alcohol monomer, an acrylate monomer and a cationic polymerizable monomer, an oligomer obtained by polymerizing one of the above group, or a mixture of oligomers,
the dibasic acid monomer is at least one monomer of fumaric acid, maleic acid and maleic anhydride acid, the acrylate monomer is at least one monomer of epoxy acrylate, urethane acrylate and polyester acrylate, and the cationic polymerizable monomer is at least one monomer of diazonium salt, diaryliodonium salt and triarylsulphonium salt, and
a thermosetting adhesive material, which is included in the adhesive resin composition or/and is attached to the circumferences of the wire pigments, is one or a mixture of two or more selected from the group consisting of a melamine monomer, a uric acid monomer, a phenolic monomer and an epoxy monomer, an oligomer obtained by polymerizing one of the above group or a mixture of oligomers, or is made of one monomer or a mixture of two or more monomers of the group.

9. The adhesive using wire pigments according to claim 1, wherein the adhesive comprises 70 to 94 wt % of the sum of the photocurable adhesive material and a thermosetting adhesive material, wherein the thermosetting adhesive material is included in the adhesive resin composition or/and is attached to the circumferences of the wire pigments, 5 to 15 wt % of the sum of a photoinitiator and a thermal initiator dispersed in the adhesive resin composition, 0.01 to 5 wt % of the wire pigments, and 0.99 to 10 wt % of other additives dispersed in the adhesive resin composition.

10. The adhesive using wire pigments according to claim 9, wherein the weight ratio of the photocurable adhesive material and the thermosetting adhesive material is 20 to 80 wt % to 80 to 20 wt %,
the weight ratio of the photoinitiator and the thermal initiator is 20 to 80 wt % to 80 to 20 wt %,
the photoinitiator comprises a radical photoinitiator or a cationic photoinitiator, wherein the radical photoinitiator comprises one or more of benzophenone, acetophenone and thioxanthone, and the cationic photoinitiator comprises onium salt or bronsted-lewis acid, and
the thermal initiator comprises peroxide or an azo compound, wherein the peroxide comprises one or more of R—O—O—R′, RCOOH, benzoyl peroxide and PhC(═O)OOC(═O)Ph, and the azo compound comprises R—N═N—R′ or Me₂C(CN)N═NC(CN)Me₂(AlBN).

11. A manufacturing method of an adhesive using wire pigments, comprising:
preparing wire pigments having a nano-sized wire structure; and
immersing the wire pigments in an adhesive resin composition including a photocurable adhesive material to have light shielding properties.

12. The manufacturing method of an adhesive using wire pigments according to claim 11, wherein the adhesive resin composition in which the wire pigments are immersed further comprises a thermosetting adhesive material.

13. The manufacturing method of an adhesive using wire pigments according to claim 11, wherein in preparing the wire pigments, a thermosetting monomer or a thermosetting oligomer, which is a thermosetting adhesive material, is attached to the circumferences of the wire pigments, and the wire pigments attached with the thermosetting adhesive material are immersed in the adhesive resin composition.

14. The manufacturing method of an adhesive using wire pigments according to claim 11, wherein in preparing the wire pigments, a thermosetting polymer resin, which is a thermosetting adhesive material, is coated on the circumferences of the wire pigments, and the wire pigments coated with the thermosetting adhesive material are immersed in the adhesive resin composition.

15. The manufacturing method of an adhesive using wire pigments according to claim 13, wherein in preparing the wire pigments, the wire pigments are dispersed in a solvent, and the thermosetting monomer or oligomer including a functional group which can be charge-coupled to the wire pigments is added to the solution in which the wire pigments are dispersed, to be attached to the circumferences of the wire pigments by self-assembly.

16. The manufacturing method of an adhesive using wire pigments according to claim 14, wherein the adhesive resin composition in which the wire pigments are immersed further comprises a thermosetting adhesive material.

17. The manufacturing method of an adhesive using wire pigments according to claim 15, wherein the adhesive resin composition in which the wire pigments are immersed further comprises a thermosetting adhesive material.

18. The manufacturing method of an adhesive using wire pigments according to claim 11, wherein the wire pigments each are at least one carbon or metal pigment selected from the group consisting of carbon (C), titanium (Ti), copper (Cu), iron (Fe), manganese (Mn), silver (Ag), cobalt (Co) and chrome (Cr) and have a wire structure with a cross-section of 10 to 300 nm and a length of 1 to 10 μm.

19. The manufacturing method of an adhesive using wire pigments according to claim 11, wherein the adhesive comprises 70 to 94 wt % of the sum of the photocurable adhesive material and a thermosetting adhesive material, wherein the thermosetting adhesive material is included in the adhesive resin composition or/and is attached to the circumferences of the wire pigments, 5 to 15 wt % of the sum of a photoinitiator and a thermal initiator dispersed in the adhesive resin composition, 0.01 to 5 wt % of the wire pigments, and 0.99 to 10 wt % of other additives dispersed in the adhesive resin composition.

20. The manufacturing method of an adhesive using wire pigments according to claim 19, wherein the weight ratio of the photocurable adhesive material and the thermosetting adhesive material is 20 to 80 wt % to 80 to 20 wt %,
the weight ratio of the photoinitiator and the thermal initiator is 20 to 80 wt % to 80 to 20 wt %,
the photocurable adhesive material is one or a mixture of two or more selected from the group consisting of a dibasic acid monomer, a dihydric alcohol monomer, an acrylate monomer and a cationic polymerizable monomer, an oligomer obtained by polymerizing one of the above group, or a mixture of oligomers, the dibasic acid monomer is at least one monomer of fumaric acid, maleic acid and maleic anhydride acid, the acrylate monomer is at least one monomer of epoxy acrylate, urethane acrylate and polyester acrylate, and the cationic polymerizable monomer is at least one monomer of diazonium salt, diaryliodonium salt and triarylsulphonium salt,
the thermosetting adhesive material is one or a mixture of two or more selected from the group consisting of a melamine monomer, a uric acid monomer, a phenolic monomer and an epoxy monomer, an oligomer obtained by polymerizing one of the above group or a mixture of oligomers, or is made of one monomer or a mixture of two or more monomers of the group, the photoinitiator comprises a radical photoinitiator or a cationic photoinitiator, wherein the radical photoinitiator comprises one or more of benzophenone, acetophenone and thioxanthone, and the cationic photoinitiator comprises onium salt or bronsted-lewis acid, and
the thermal initiator comprises peroxide or an azo compound, wherein the peroxide comprises one or more of R—O—O—R′, RCOOH, benzoyl peroxide and PhC(═O)OOC(═O)Ph, and the azo compound comprises R—N═N—R′ or Me₂C(CN)N═NC(CN)Me₂(AlBN).
